(19) United States
(12) Patent Application Publication
(10) Pub. No.: US 2019/0185202 A1
(43) Pub. Date: Jun. 20, 2019

(54) Container with Surface Features

(71) Applicant: Graphic Packaging International, LLC, Atlanta, GA (US)

(72) Inventors: Aaron Bates, Kennesaw, GA (US); Steven M. Oliveira, Canton, GA (US)

(21) Appl. No.: 16/202,509

(22) Filed: Nov. 28, 2018

Related U.S. Application Data
(60) Provisional application No. 62/599,292, filed on Dec. 15, 2017.

(51) Int. Cl. B65D 5/56; B65D 5/24; B65D 5/42; B65D 81/38; A47J 47/14; B65D 5/66; B65D 85/36; B31B 50/26

(52) U.S. Cl. CPC B65D 5/563; B65D 5/241; B65D 5/4266; B65D 81/3813; B31B 50/25; B65D 5/6658; B65D 85/36; B31B 50/26; B65D 2585/366; A47J 47/145

(57) ABSTRACT

A container for holding at least one article includes a lid foldably connected to a tray, the lid and the tray extending at least partially around an interior of the container. The tray includes a material having an outer layer defining an exterior surface of the container and an inner layer defining an interior surface of the container. The interior surface includes surface features for supporting the at least one article, and the surface features comprise a plurality of protrusions, with adjacent protrusions of the plurality of protrusions defining respective channels of a plurality of channels.

### CROSS-REFERENCE TO RELATED APPLICATION

This application claims the benefit of U.S. Provisional Patent Application No. 62/599,292, filed on Dec. 15, 2017.

### INCORPORATION BY REFERENCE

The disclosure of U.S. Provisional Patent Application No. 62/599,292, filed on Dec. 15, 2017, is hereby incorporated by reference for all purposes as if presented herein in its entirety.

### BACKGROUND OF THE DISCLOSURE

The present disclosure generally relates to containers for holding at least one food product, blanks for forming such containers, and methods of forming such containers. In one embodiment, the present disclosure relates to a container having surface features for maintaining one or more properties of a food product.

### SUMMARY OF THE DISCLOSURE

In one aspect of the disclosure, a container for holding at least one article comprises a lid and a tray extending at least partially around an interior of the container, and the lid is foldably connected to the tray. The tray comprises a material having an outer layer defining an exterior surface of the container and an inner layer defining an interior surface of the container. The interior surface comprises surface features for supporting the at least one article, the surface features comprise a plurality of protrusions, and adjacent protrusions of the plurality of protrusions define respective channels of a plurality of channels.

In another aspect of the disclosure, a blank for forming a container for holding at least one article comprises a lid portion foldably connected to a tray portion, and the lid portion and the tray portion are for forming a lid and a tray extending at least partially around an interior of the container formed from the blank. The tray portion comprises a material having an outer layer defining an exterior surface of the blank and an inner layer defining an interior surface of the container, the interior surface comprises surface features for supporting the at least one article, the surface features comprise a plurality of protrusions, and adjacent protrusions of the plurality of protrusions define respective channels of a plurality of channels.

In another aspect of the disclosure, a method of forming a container for holding at least one article comprises obtaining a blank for forming a container for holding at least one article, the blank comprising a lid portion foldably connected to a tray portion, the tray portion comprises a material having an outer layer defining an exterior surface of the blank and an inner layer defining an interior surface of the blank. The interior surface comprises surface features for supporting the at least one article, the surface features comprise a plurality of protrusions, and adjacent protrusions of the plurality of protrusions define respective channels of a plurality of channels. The method further comprises forming a lid from the lid portion of the blank and forming a tray from the tray portion of the blank, the lid and the tray extend at least partially around an interior of the container.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a container according to an exemplary embodiment of the disclosure.

FIG. 2 is a plan view of an interior surface of the blank of FIG. 1.

FIG. 3 is a schematic cross-sectional view of a portion of the blank as shown in FIG. 2, showing surface features on the interior surface of the blank.

FIG. 4 is a perspective view of a partial folding operation of a container formed from the blank of FIG. 1 according to an exemplary embodiment of the disclosure.

FIG. 5 is a perspective view of a container formed from the blank of FIG. 1 in an open configuration.

FIG. 6 is a schematic cross-sectional view of a portion of the container of FIG. 5 and supporting a food product.

FIG. 7 is a perspective view of the container of FIG. 5 in a closed configuration.

Corresponding parts are designated by corresponding reference numbers throughout the drawings.

### DETAILED DESCRIPTION

Containers according to the present disclosure can accommodate articles of numerous different shapes. In this specification, the terms “lower,” “bottom,” “upper,” “top,” “front,” and “back” indicate orientations determined in relation to fully erected containers. As described herein, containers may be formed by multiple overlapping portions, panels, walls, and/or end flaps. Such portions, panels, walls, and/or end flaps may be designated in relative terms to one another, e.g., “first”, “second”, “third”, etc., in sequential or non-sequential reference, without departing from the disclosure.

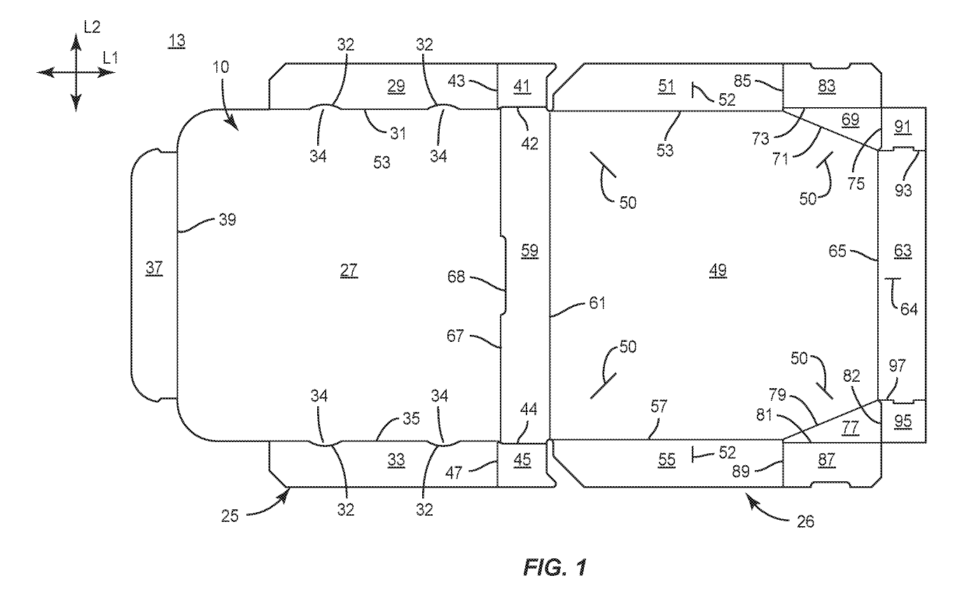

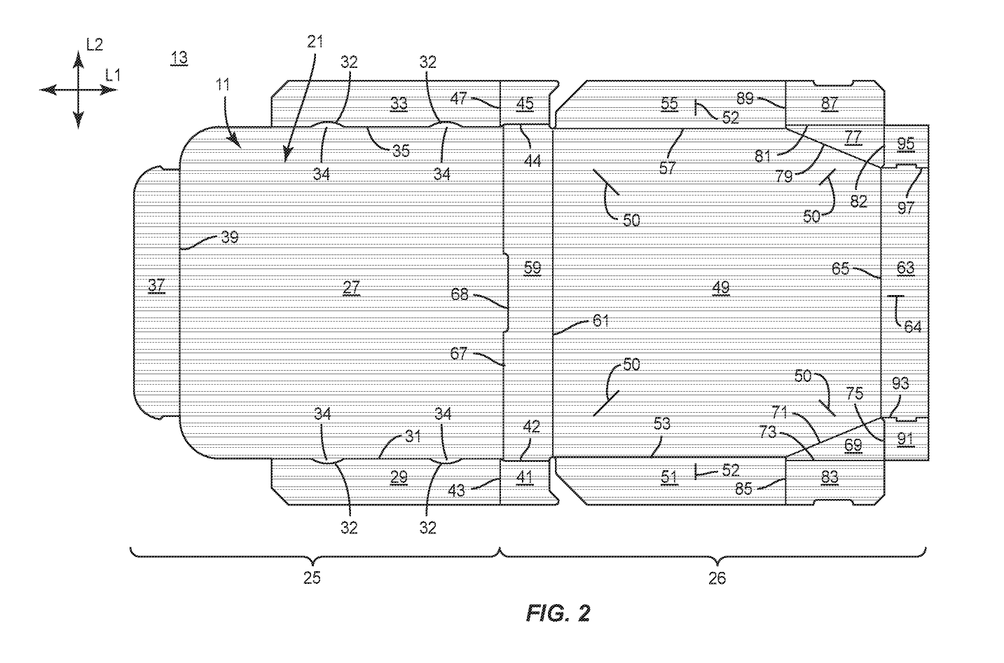

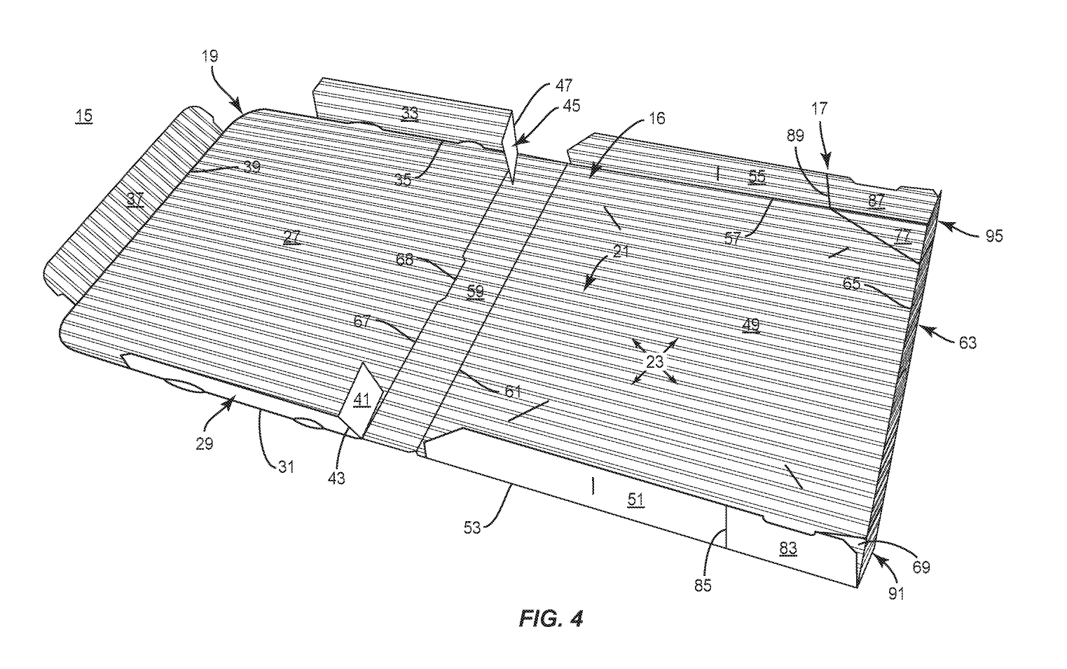

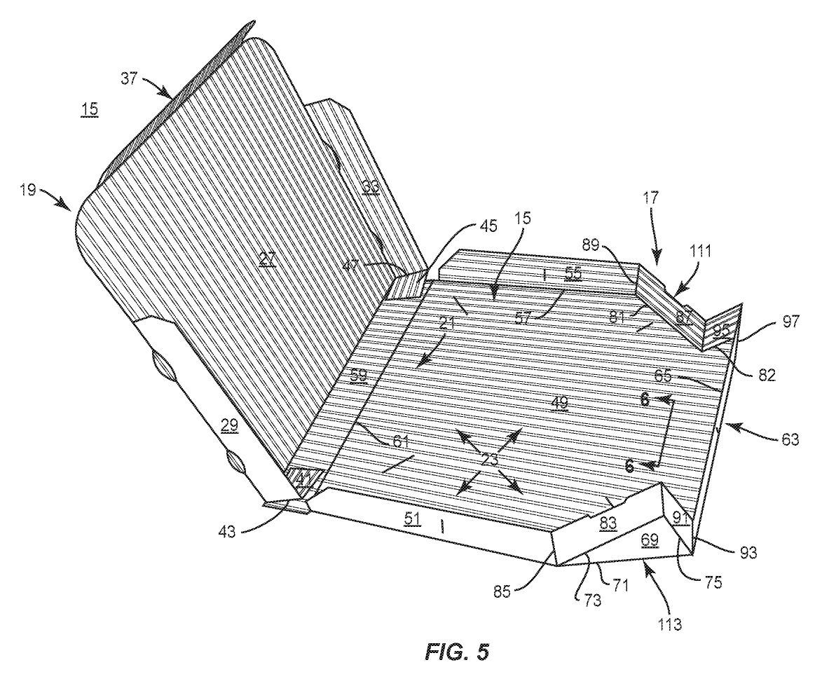

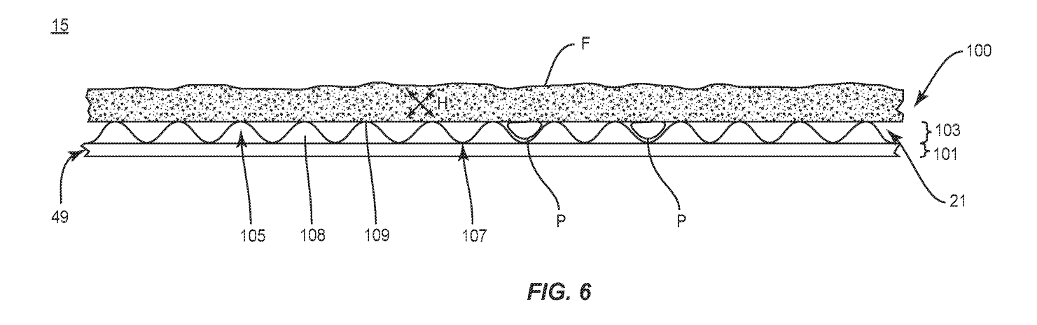

According to one exemplary embodiment of the disclosure, FIGS. 1 and 2 show a blank 13 for forming a container 15 (FIG. 5) according to an exemplary embodiment of the disclosure, with FIG. 1 showing an exterior surface 10 of the blank and FIG. 2 showing an interior surface 11 of the blank 13. As described herein, the container 15 comprises a tray 17 and a reclosable lid 19 foldably connected to the tray 17. The illustrated container 15 is suitable for holding one or more articles such as one or more food products F (FIG. 6), for example, a pizza, calzone, sandwich, roll, and/or any other food item, e.g., for storage, transport, and/or delivery to a customer. In this regard, in one embodiment, the container 15 can be broadly referred to as a pizza box. Other types of food products, which may or may not be provided with additional packaging, can be placed in the container 15 for storage, transport, and/or delivery to a customer without departing from the disclosure. As described further herein, the interior surface 11 of the blank 13 includes surface features 21 for accommodating the food product F and/or maintaining a property of the food product F. As the interior surface 11 of the blank 13 forms the interior surface 16 (FIG. 4) of the container 15, the surface features 21 are provided on a portion of the container 15 facing an interior 23 (FIG. 4) of the container 15. The container 15 could be otherwise shaped and arranged and/or could be used to hold other products and/or articles in similar or different environments without departing from the disclosure. For example, the container 15 could be configured in any suitable configuration for carrying a heated food product without departing from the disclosure.

As shown in FIG. 1, the blank 13 has a longitudinal axis L1 extending generally in the direction of the length of the blank 13 and a lateral axis L2 extending generally in the direction of the width of the blank 13. The blank 13, as shown, includes a lid portion 25 for forming the lid 19 of the container 15 and a tray portion 26 for forming the tray 17 of the container 15. In one embodiment, the lid portion 25 and the tray portion 26 are separate sections of material that are joined, e.g., glued, adhered, bridged, or taped, to name a few, to form the blank 13. In another embodiment, the lid portion 25 and the tray portion 26 are sections of a unitary blank 13. The exterior surface 10 of the blank 13 can be substantially smooth or planar, and can receive one or more visual indicia, for example, graphics and/or text. In one embodiment, the exterior surface 10 of the blank 13 can be substantially devoid of surface features.

Still referring to FIG. 1, as shown, the lid portion 25 of the blank 13 includes a top panel 27, a first lid side flap 29 foldably connected to the top panel 27 at a longitudinal fold line 31, a second lid side flap 33 foldably connected to the top panel 27 at a longitudinal fold line 35, and a lid front flap 37 foldably connected to the top panel 27 at a lateral fold line 39. As illustrated, a first back flap 41 is foldably connected to the first lid side flap 29 at a lateral fold line 43, and a second back flap 45 is foldably connected to the second lid side flap 33 at a lateral fold line 47. As also shown, curved cuts 32 can be provided that interrupt portions of the respective fold line 21, 35 to define tabs 34 in the lid portion 25.

The tray portion 26 of the blank 13, as shown, includes a bottom panel 49, a first tray side flap 51 foldably connected to the bottom panel 49 at a longitudinal fold line 53 and a second tray side flap 55 foldably connected to the bottom panel 49 at a longitudinal fold line 57. A back panel 59 is foldably connected to the bottom panel 49 at a lateral fold line 61, and a tray front flap 63 is foldably connected to the bottom panel 49 at a lateral fold line 65. As illustrated, the back panel 59 is foldably connected to the top panel 27 at a longitudinal fold line 67 such that the lid portion 25 of the blank 13 is foldably connected to the tray portion 26 of the blank 13 via the back panel 59 at the longitudinal fold line 67. As shown, a cut 68 can interrupt a portion of the fold line 67. In one embodiment, the back panel 59 is at least partially defined by two respective longitudinal cuts 42, 44 between the back panel 59 and a respective back flap 41, 45 of the lid portion 25 of the blank 13.

In the illustrated embodiment, the tray portion 26 of the blank 13 comprises a first gusset panel 69 that is foldably connected to the bottom panel 49 at an oblique fold line 71. A second gusset panel 77 is foldably connected to the bottom panel 49 at an oblique fold line 79 in the blank 13. A first gusset side flap 83 is foldably connected to the first tray side flap 51 at a lateral fold line 85 and is foldably connected to the first gusset panel 69 at a longitudinal fold line 73. A second gusset side flap 87 is foldably connected to the second tray side flap 55 at a lateral fold line 89 and is foldably connected to the second gusset panel 77 at a longitudinal fold line 81. As shown, the tray portion 26 of the blank 13 comprises a first gusset front flap 91 foldably connected to the first gusset panel 69 at a lateral fold line 75 and foldably connected to the tray front flap 63 at a longitudinal fold line 93 that can be interrupted by one or more cuts. The tray portion 26 also includes a second gusset front flap 95 foldably connected to the second gusset panel 77 at a lateral fold line 82 and foldably connected to the tray front flap 63 at a longitudinal fold line 97 that can be interrupted by one or more cuts. As illustrated, the fold lines 71, 73, 75 can be arranged to intersect each other, and the fold lines 79, 81, 82 can be arranged to intersect each other. As also shown, lateral cuts 52 can be provided on the respective first tray side flap 51 and the second tray side flap 55, a longitudinal cut 64 can be provided on a portion of the tray front flap 63, and oblique cuts 50 can be provided on the bottom panel 49. The blank 13 can have a different arrangement of panels, flaps, fold lines and/or cuts without departing from the disclosure.

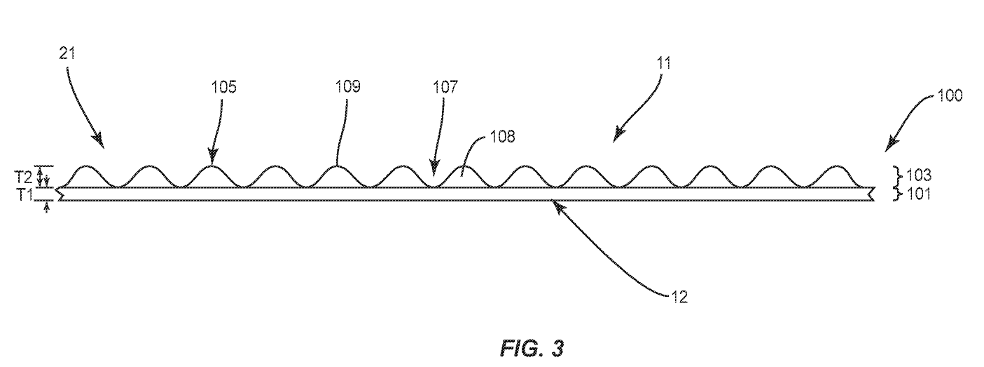

Referring to FIGS. 1-3, the blank 13 and the container 15 are formed from a material 100 that defines the outer surface 12 and the interior surface 11 with the surface features 21. In this regard, the material 100 can include an outer layer 101 and an inner layer 103 that includes surface features 21. The outer layer 101 and the inner layer 103 can be joined, for example, with an adhesive such as glue, or can be otherwise laminated. The material 100 can include additional layers without departing from the disclosure. In one embodiment, the material 100 can be formed of a single layer of material that includes the surface features 21 on one side thereof. In one embodiment, the outer layer 101 can be a linerboard and the inner layer 103 can be corrugated sheet, for example, a fluted sheet, such that the material 100 can broadly be referred to as a single-faced structure. In such an arrangement, one side of the inner layer 103 is devoid of a liner, linerboard, or other covering adjacent the surface features 21. In one embodiment, the outer layer 101 is a relatively thin layer having a first thickness T1 (e.g., paper or any other suitable corrugated liner) and the inner layer 103 is a layer (e.g., paperboard or other suitable corrugated medium) that has a second thickness T2 that is greater than the thickness T1 of the outer layer 101. Alternatively, the material of the outer layer 101 and the inner layer 103 could have the same thickness without departing from the disclosure. Also, the outer layer 101 and/or inner layer could comprise any suitable material (e.g., Kraft container board, coated paperboard, uncorked paperboard, paper, etc.) without departing from the disclosure.

As shown, the inner layer 103 has a waveform shape with the surface features 21 including a plurality of protrusions 105 spaced apart by respective channels 107 disposed and/or defined between and/or separating adjacent protrusions 105. As shown, each respective channel 107 can include substantially the entire region of the inner layer 103 between each respective adjacent protrusion 105 such that respective channels 107 parallel with respective protrusions 105. The protrusions 105 and channels 107 can have the same or similar lengths, or can have differing lengths without departing from the disclosure.

In this regard, the protrusions 105 and the channels 107 can form an alternating pattern such as that in a wave pattern, for example, a sinusoidal wave pattern. In this regard, the protrusions 105 and the channels 107 can form a pattern of the material 100 that can broadly be referred to as a single-face corrugated material or ribbed material. As shown, the channels 107 can extend longitudinally, or can have a different orientation, such as a laterally-extending or obliquely-extending orientation. In one embodiment, one or more of the protrusions 105 and/or the channels 107 can have a different cross-sectional configuration, for example, a configuration that is at least partially square, rectangular, triangular, or ovoid in cross-section. The protrusions 105 and/or the channels 107 could have other shapes without departing from the disclosure.

As shown, the protrusions 105 can have a hollow cross-sectional configuration, for example, such that a chamber 108 is defined between each protrusion 105 and the outer layer 101. In an alternative embodiment, the inner layer 103 can be configured such that the protrusions 105 have a substantially solid cross-sectional configuration such that no chamber is defined between the protrusions 105 and the outer layer 101. In the illustrated embodiment, each protrusion 105, as shown, has a curved configuration that presents an upper-facing or food-contacting surface 109 for supporting one or more food products F (FIG. 6). In this regard, the protrusions 105 can be configured with a curvature that extends toward the outer layer 101, e.g., such that each protrusion 105 has a convex configuration relative to the outer layer 101. In one embodiment, the protrusions 105 can have a concave or other configuration. While the protrusions 105 have been illustrated with the substantially similar configuration shown, one or more protrusion 105 can have a different configuration, for example, a cross-sectional configuration that is at least partially square, rectangular, triangular, or ovoid in cross-section, without departing from the disclosure.

Each channel 107, as shown, has a curved configuration that can support, for example, portions of food products F, at a vertical position spaced above and away from the outer layer 101. In this regard, each channel 107 has a curvature that extends away from the outer layer 101, e.g., such that each channel 107 has a concave configuration relative to the outer layer 101. While the channels 107 have been illustrated with the substantially similar configuration shown, one or more channels 107 can have a different configuration, for example, a cross-sectional configuration that is at least partially square, rectangular, triangular, or ovoid in cross-section, without departing from the disclosure. In this regard, the arrangement of the surface features 21 is such that a plurality of food-contacting surfaces 109 is provided spaced apart from one another, e.g., by respective channels 107.

Referring additionally to FIG. 4, formation of the container 15 from the blank 13 will be described according to one exemplary method of the disclosure. Formation of the lid 19 can proceed by folding the first lid side flap 29 at the fold line 31, folding the second lid side flap 33 at the fold line 35, and folding the lid front flap 37 at the fold line 39, all to respective substantially upright, e.g., substantially perpendicular, configurations relative to the top panel 27. Similarly, formation of the tray 17 can proceed by folding the first tray side flap 51 at the fold line 53, folding the second tray side flap 55 at the fold line 57, folding the back panel 59 at the fold line 61, and folding the tray front flap 63 at the fold line 65, all to respective substantially upright configurations relative to the bottom panel 49. In this regard, portions of the blank 13 are folded to at least partially extend around the interior 23 of the container 15.

Still referring to FIG. 1, and referring additionally to FIG. 5, the respective first back flap 41 and second back flap 45 can be folded at the respective fold lines 43, 47 into substantially perpendicular relation with the respective first lid side flap 29 and second lid side flap 33 and into at least partial overlapping relation with the back panel 59, for example, into at least partial face-to-face contact with the back panel 59. Such arrangement of the first back flap 41 and the second back flap 45 adjacent the back panel 59 can, for example, provide reinforcement during opening and closing of the lid 19. In one embodiment, the first back flap 41 and the second back flap 45 can be joined to the back panel 59, for example, with an adhesive such as glue. As also shown, the respective gusset panels 69, 77 can be folded at the respective oblique lines of weakening 71, 79 into overlapping relation, e.g., at least partial face-to-face contact, with the bottom panel 49. The folding of the first gusset panel 69 as described above draws the first gusset side flap 83 to at least partially fold at the fold line 73 into substantially upright relation with respect to the bottom panel 49 and to at least partially fold at the fold line 85. Such folding of the first gusset panel 69 also draws the first gusset front flap 91 to at least partially fold at the fold line 75 into substantially upright relation to the bottom panel 49 and to at least partially fold at the fold line 93, thus forming a first gusset 111 with the first gusset side flap 83 and the first gusset front flap 91 disposed in oblique relation with both the first tray side flap 51 and the tray front flap 63. Similarly, the folding of the second gusset panel 77 as described above draws the second gusset side flap 87 to at least partially fold at the fold line 81 into substantially upright relation to the bottom panel 49 and to at least partially fold at the fold line 89. Further, such folding of the second gusset panel 77 and draws the second gusset front flap 95 to at least partially fold at the fold line 82 into substantially upright relation to the bottom panel 49 and to at least partially fold at the fold line 97, thus forming a second gusset 113 with the second gusset side flap 87 and the second gusset front flap 95 are disposed in oblique relation with both the second tray side flap 55 and the tray front flap 63. The above-described folding of the gusset panels 69, 77 may occur at a different point during formation of the container 15 without departing from the disclosure. In one embodiment, the gussets 111, 113 can provide a visually-distinctive appearance of the container 15 and/or can facilitate interengagement of a container with another container, a shipping structure, and/or a storage structure. In addition, at least a portion of the top panel 27 can protrude over one or both of the gussets 111, 113, for example, to provide a surface or ledge by which a user can engage and lift the lid 19 from the tray 17.

In the assembled and open configuration of the container 15 illustrated herein, a food product F (FIG. 6) can be placed in the interior 23 of the container 15, for example, resting upon the bottom panel 49.

Referring additionally to the cross-sectional view of FIG. 6 taken along the line 6-6 of FIG. 5, a portion of the bottom panel 49 comprised of the material 100 and supporting the food product F is illustrated. As described above, the inner layer 103 is devoid of a liner, linerboard, or other covering over the protrusions 105. Accordingly, the food product F is supported on the surface features 21 of the interior surface 16 of the container 15 such that the food-contacting surfaces 109 of one or more of the protrusions 105 are in contact with the food product F and such that the food product F overlies one or more of the channels 107.

In this regard, the surface features 21 provide a discontinuous surface along which the food product F is supported. In one embodiment, the food product F is a heated food product such that at least a portion of the heat H of the food product F can be transmitted to air in the channels 107. In this regard, the channels 107 and the overlying food product F create spaces of heated air below the food product F such that at least a portion of the heat H of the food product F is maintained in one or more of the channels 107 and is in convective contact with the food item F, for example, to contribute to maintaining a condition such as the temperature of the food item F. Additionally, heat H in the channels 107 is inhibited or prevented from escaping into upper portions of the interior 23 of the container 15 to minimize, inhibit, and/or prevent heat losses from the food item F. In one embodiment, the one or more channels 107 beneath the food product F provide a degree of thermal insulation for the food product F that maintains the temperature of the heated food product F. It will be understood that one or more of the chambers 108 below the protrusions 105 can additionally or alternatively maintain heat H to minimize, inhibit, and/or prevent heat losses from the food item F and/or provide a degree of thermal insulation for the food product F as described above with regard to the channels 107.

Furthermore, the channels 107 can support and/or capture a portion P of the food product F that may become separated from the food product F, for example, runoff from the food product F (e.g., oil or grease) or particulate from the food product F (e.g., crumbs) that falls into one or more of the channels 107, for example, due to shifting and/or under the influence of gravity. The channels 107 can also support moisture from the environment in the interior 23 of the container 15 (e.g., vapor or condensation from steam). In this regard, the channels 107 can provide pathways for runoff, or drainage from the food product F and/or the surrounding environment, for example, to maintain a desired condition, e.g., crispness, minimization of grease buildup, minimization of pooling or soaking of liquids, etc., of the food product F.

Accordingly, and as described herein, the surface features 21 provide thermally insulative properties for the food product F and the container 15 as well as being configured for capturing and/or draining runoff and/or particulate from the food product F and/or moisture from the surrounding environment. Such advantages are provided by the configuration of the surface features 21, which can provide ecological advantages and cost savings compared to, for example, conventional containers that lack such surface features. For example, because the inner layer 103 is devoid of a liner, linerboard, or other covering adjacent the surface features 21, cost and materials savings are realized with respect to such liner, linerboard, or other covering.

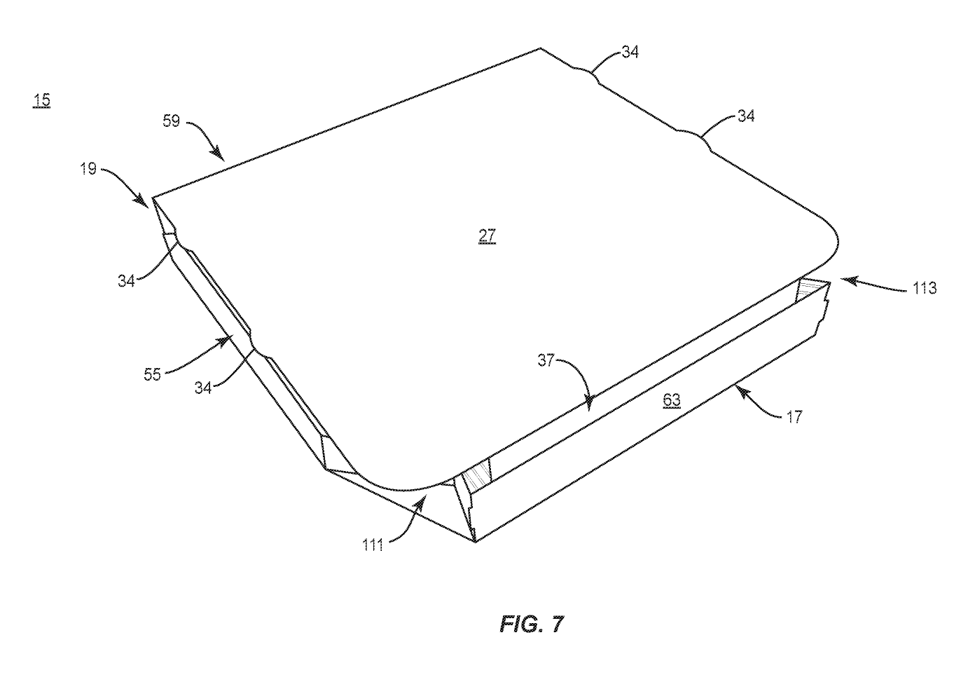

Referring additionally to FIG. 7, the container 15 is illustrated in a closed condition, with the lid side flaps 29, 33 and the lid front flap 37 tucked into the interior 23 of the container 15 adjacent the respective tray side flaps 51, 55 and the tray front flap 63. In this regard, the lid 19 and the tray 17 can together provide an enclosure, for example, to maintain a desired condition of the interior 23 of the container 15 or a food product F disposed therein. A user can selectively open the container 15 by lifting upwardly along a portion of the lid 19, for example, a portion of the top panel 27 of the lid 19 extending over one or both of the gusset panels 69, 77 and/or one or more of the tabs 34 such that the lid 19 hingably raises relative to the tray 17 at the fold line 67.

In general, the blanks described herein may be constructed from paperboard having a caliper so that it is heavier and more rigid than ordinary paper. The blanks can also be constructed of other materials, such as cardboard, sheet plastics or any other material having properties suitable for enabling the containers to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the container embodiments. The term “glue” is intended to encompass all manner of adhesives commonly used to secure portions of the container in place, and is not intended to exclude heat, chemical, or frequency bonding techniques.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one article, the container comprising:
a lid and a tray extending at least partially around an interior of the container, the lid foldably connected to the tray,
the tray comprises a material having an outer layer defining an exterior surface of the container and an inner layer defining an interior surface of the container, the interior surface comprises surface features for supporting the at least one article, the surface features comprise a plurality of protrusions, adjacent protrusions of the plurality of protrusions define respective channels of a plurality of channels.

2. The container of claim 1, wherein the plurality of protrusions define at least one food-contacting surface of the container.

3. The container of claim 2, wherein the inner layer is devoid of a liner adjacent the plurality of protrusions.

4. The container of claim 2, wherein the at least one food-contacting surface of the container is a plurality of food-contacting surfaces of the container, and adjacent food-contacting surfaces are spaced apart from one another.

5. The container of claim 4, wherein adjacent food-contacting surfaces are spaced apart by respective channels of the plurality of channels.

6. The container of claim 5, wherein the plurality of protrusions and the plurality of channels are arranged in parallel relation.

7. The container of claim 6, wherein the plurality of protrusions and the plurality of channels are arranged in a sinusoidal wave pattern.

8. The container of claim 6, wherein the material is a single-face corrugated material.

9. The container of claim 1, wherein at least one protrusion of the plurality of protrusions has a hollow configuration.

10. The container of claim 9, wherein a chamber is defined between the at least one protrusion and the outer layer.

11. The container of claim 1, wherein the outer layer has a first thickness and the inner layer has a second thickness that is greater than the first thickness.

12. The container of claim 1, wherein each protrusion of the plurality of protrusions has a convex configuration relative to the outer layer.

13. The container of claim 12, wherein each channel of the plurality of channels has a concave configuration relative to the outer layer.

14. The container of claim 1, wherein the plurality of protrusions support the at least one article at a vertical position spaced away from the outer layer.

15. The container of claim 1, wherein the tray comprises a bottom panel, a tray front flap foldably connected to the bottom panel, a back panel foldably connected to the bottom panel, and at least one tray side flap foldably connected to the bottom panel.

16. The container of claim 15, wherein the lid is foldably connected to the tray back panel, the lid comprises a top panel, at least one lid side flap foldably connected to the top panel, and a lid front flap foldably connected to the top panel.

17. The container of claim 16, wherein the bottom panel comprises the material.

18. The container of claim 17, wherein the tray comprises at least one gusset between the tray front flap and the at least one tray side panel.

19. The container of claim 18, wherein a portion of the top panel protrudes over the at least one gusset.

20. A blank for forming a container for holding at least one article, the blank comprising:
a lid portion foldably connected to a tray portion, the lid portion and the tray portion are for forming a lid and a tray extending at least partially around an interior of the container formed from the blank,
the tray portion comprises a material having an outer layer defining an exterior surface of the blank and an inner layer defining an interior surface of the container, the interior surface comprises surface features for supporting the at least one article, the surface features comprise a plurality of protrusions, adjacent protrusions of the plurality of protrusions define respective channels of a plurality of channels.

21. The blank of claim 20, wherein the plurality of protrusions define at least one food-contacting surface.

22. The blank of claim 21, wherein the inner layer is devoid of a liner adjacent the plurality of protrusions.

23. The blank of claim 21, wherein the at least one food-contacting surface is a plurality of food-contacting surfaces, and adjacent food-contacting surfaces are spaced apart from one another.

24. The blank of claim 23, wherein the material is a single-face corrugated material.

25. The blank of claim 20, wherein at least one protrusion of the plurality of protrusions has a hollow configuration.

26. The blank of claim 20, wherein the tray portion comprises a bottom panel, a tray front flap foldably connected to the bottom panel, a back panel foldably connected to the bottom panel, at least one tray side flap foldably connected to the bottom panel, and the tray comprises at least one gusset between the tray front flap and the at least one tray side panel.

27. A method of forming a container for holding at least one article, the method comprising:
obtaining a blank for forming a container for holding at least one article, the blank comprising a lid portion foldably connected to a tray portion, the tray portion comprises a material having an outer layer defining an exterior surface of the blank and an inner layer defining an interior surface of the blank, the interior surface comprises surface features for supporting the at least one article, the surface features comprise a plurality of protrusions, adjacent protrusions of the plurality of protrusions define respective channels of a plurality of channels; and
forming a lid from the lid portion of the blank and forming a tray from the tray portion of the blank, the lid and the tray extend at least partially around an interior of the container.

28. The method of claim 27, wherein the plurality of protrusions define at least one food-contacting surface.

29. The method of claim 28, wherein the inner layer is devoid of a liner adjacent the plurality of protrusions.

30. The method of claim 28, wherein the at least one food-contacting surface is a plurality of food-contacting surfaces, and adjacent food-contacting surfaces are spaced apart from one another.

31. The method of claim 30, wherein the material is a single-face corrugated material.

32. The method of claim 27, wherein at least one protrusion of the plurality of protrusions has a hollow configuration.

33. The method of claim 27, wherein the tray comprises a bottom panel, a tray front flap foldably connected to the bottom panel, a back panel foldably connected to the bottom panel, at least one tray side flap foldably connected to the bottom panel, and the tray comprises at least one gusset between the tray front flap and the at least one tray side panel.
